(19) United States
(12) Patent Application Publication
(10) Pub. No.: US 2021/0115218 A1
(43) Pub. Date: Apr. 22, 2021

(54) RUBBER COMPOSITION COMPRISING A REINFORCING FILLER WITH A SMALL SPECIFIC SURFACE AREA

(71) Applicant: COMPAGNIE GENERALE DES ETABLISSEMENTS MICHELIN, Clermont-Ferrand (FR)

(72) Inventors: KATIA BARAN, Clermont-Ferrand (FR); NATHALIE SALGUES, Clermont-Ferrand (FR)

(21) Appl. No.: 17/046,338

(22) PCT Filed: Apr. 1, 2019
(86) PCT No.: PCT/FR2019/050751

§ 371 Date: Oct. 9, 2020

(30) Foreign Application Priority Data
Apr. 9, 2018 (FR) 1853079

(51) Int. Cl. C08K 3/04; B60C 9/22; B60C 1/00

(52) U.S. Cl. CPC C08K 3/04; B60C 9/22; B60C 2009/2016; C08K 2201/006; B60C 1/0041

(57) ABSTRACT

The invention relates to a rubber composition based on an elastomeric matrix comprising at least 90 phr of at least one isoprene elastomer, on a reinforcing filler predominantly comprising at least one carbon black, known as CB black, exhibiting a BET specific surface at most equal to 30 m²/g and an oil absorption index of compressed sample (COAN) at least equal to 60 ml/100 g, and on a crosslinking system, the said composition not comprising, or comprising at most 10 phr of, carbon black, the BET specific surface of which is greater than 30 m²/g and the COAN of which is greater than 40 ml/100 g, and not comprising, or comprising at most 10 phr of, silica.

### TECHNICAL FIELD OF THE INVENTION

The present invention relates to a rubber composition predominantly comprising an isoprene elastomer and to a tyre comprising this composition.

### PRIOR ART

Current tyres are required to roll many kilometers. The conditions of use of tyres can lead them to reach high temperatures, in particular at the crown, especially when they support heavy loads. An ongoing concern of manufacturers is thus to develop tough tyres, that is to say tyres, the properties of which change little over time, and which exhibit a low rolling resistance.

The document FR 2 981 298 discloses a tyre comprising a layer of rubbery material positioned between the ends of the two working crown plies, based on a predominantly isoprene elastomeric matrix and on a reinforcing filler consisting either of carbon black with a BET specific surface of greater than 60 m²/g, or of a white filler of silica and/or alumina type, this layer exhibiting a modulus of elasticity under tension at 10% elongation of less than 8 MPa and a maximum tan(delta) value of less than 0.10.

The tyres thus produced make it possible effectively to improve the performance qualities, in particular in terms of endurance and of rolling resistance.

On continuing its research studies, the Applicant Company has discovered that the use of a specific reinforcing filler makes it possible to further improve the rolling resistance and the endurance of tyres.

### DETAILED DESCRIPTION OF THE INVENTION

The invention relates to a rubber composition based:
on an elastomeric matrix comprising at least 90 phr of at least one isoprene elastomer;
on a reinforcing filler predominantly comprising at least one carbon black, known as CB black in the context of the present invention, exhibiting a BET specific surface at most equal to 30 m²/g and an oil absorption number of compressed sample (COAN) at least equal to 60 ml/100 g;
on a crosslinking system;

the said composition not comprising, or comprising at most 10 phr of, carbon black, the BET specific surface of which is greater than 30 m²/g and the COAN of which is greater than 40 ml/100 g, and not comprising, or comprising at most 10 phr of, silica.

### Definitions

The expression “part by weight per hundred parts by weight of elastomer” (or phr) should be understood as meaning, within the meaning of the present invention, the part by weight per hundred parts by weight of elastomer or of rubber, the two terms being synonyms.

In the present document, unless expressly indicated otherwise, all the percentages (%) indicated are percentages (%) by weight.

Moreover, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b). In the present document, when an interval of values is denoted by the expression “from a to b”, the interval represented by the expression “between a and b” is also and preferably denoted.

When reference is made to a “predominant” compound, this is understood to mean, within the meaning of the present invention, that this compound is predominant among the compounds of the same type in the composition, that is to say that it is the one which represents the greatest amount by weight among the compounds of the same type. Thus, for example, a predominant polymer is the polymer representing the greatest weight, with respect to the total weight of the polymers in the composition. In the same way, a “predominant” filler is that representing the greatest weight among the fillers of the composition. By way of example, in a system comprising just one polymer, the latter is predominant within the meaning of the present invention and, in a system comprising two polymers, the predominant polymer represents more than half of the weight of the polymers. Preferably, the term “predominant” is understood to mean present at more than 50%, preferably more than 60%, 70%, 80%, 90%, and more preferentially the “predominant” compound represents 100%.

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the noncrosslinked state.

The circumferential direction of the tyre, or longitudinal direction, is the direction corresponding to the periphery of the tyre and defined by the direction of rolling of the tyre.

The transversal or axial direction of the tyre is parallel to the axis of rotation of the tyre.

The radial direction is a direction which crosses the axis of rotation of the tyre and is perpendicular thereto.

The axis of rotation of the tyre is the axis about which it turns in normal use.

A radial or meridian plane is a plane which contains the axis of rotation of the tyre.

The circumferential median plane, or equatorial plane, is a plane perpendicular to the axis of rotation of the tyre which divides the tyre into two halves.

The compounds comprising carbon mentioned in the description can be of fossil origin or biosourced. In the latter case, they can result, partially or completely, from biomass or be obtained from renewable starting materials resulting from biomass. Polymers, plasticizers, fillers, and the like, are concerned in particular.

Elastomers

The rubber composition according to the invention is based on at least 90 phr of at least one isoprene elastomer. Thus, the composition according to the invention can contain just one isoprene elastomer or a mixture of one or more isoprene elastomers with one or more other elastomers.

The composition according to the invention can also comprise any type of non-isoprene diene elastomer, or elastomer other than a diene elastomer, such as, for example, olefinic or thermoplastic elastomers.

A “diene” elastomer (or, without distinction, rubber), whether natural or synthetic, should be understood, in a known way, as meaning an elastomer composed, at least in part (i.e., a homopolymer or a copolymer), of diene monomer units (monomers bearing two conjugated or non-conjugated carbon-carbon double bonds).

These diene elastomers can be classified into two categories: “essentially unsaturated” or “essentially saturated”. “Essentially unsaturated” is generally understood to mean a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low content, always less than 15%, of units of diene origin).

“Diene elastomer capable of being used in the compositions in accordance with the invention” is understood particularly to mean:
(a) any homopolymer of a conjugated or non-conjugated diene monomer having from 4 to 18 carbon atoms;
(b) any copolymer of a conjugated or non-conjugated diene having from 4 to 18 carbon atoms and of at least one other monomer.

The other monomer can be ethylene, an olefin or a conjugated or non-conjugated diene.

Suitable as conjugated dienes are conjugated dienes having from 4 to 12 carbon atoms, especially 1,3-dienes, such as, in particular, 1,3-butadiene and isoprene.

Suitable as non-conjugated dienes are non-conjugated dienes having from 6 to 12 carbon atoms, such as 1,4-hexadiene, ethylidenenorbornene or dicyclopentadiene.

Suitable as olefins are vinylaromatic compounds having from 8 to 20 carbon atoms and aliphatic α-monoolefins having from 3 to 12 carbon atoms.

Suitable as vinylaromatic compounds are, for example, styrene, ortho-, meta- or para-methylstyrene, the “vinyltoluene” commercial mixture or para-(tert-butyl)styrene.

Suitable as aliphatic α-monoolefins are in particular acyclic aliphatic α-monoolefins having from 3 to 18 carbon atoms.

More particularly, the diene elastomer is:
(a′) any homopolymer of a conjugated diene monomer, in particular any homopolymer obtained by polymerization of a conjugated diene monomer having from 4 to 12 carbon atoms;
(b′) any copolymer obtained by copolymerization of one or more conjugated dienes with one another or with one or more vinylaromatic compounds having from 8 to 20 carbon atoms;
(c′) any copolymer obtained by copolymerization of one or more conjugated or non-conjugated dienes with ethylene, an α-monoolefin or their mixture, such as, for example, the elastomers obtained from ethylene, from propylene with a non-conjugated diene monomer of the abovementioned type.

The diene elastomer can be modified, that is to say coupled and/or star-branched or else functionalized with a coupling and/or star-branching or functionalization agent.

Thus, the diene elastomer can be coupled and/or star-branched, for example by means of a silicon or tin atom which connects the elastomer chains together.

The diene elastomer can be simultaneously or alternatively functionalized and comprise at least one functional group. The term “functional group” is understood to mean a group comprising at least one heteroatom chosen from Si, N, S, O or P. Particularly suitable as functional groups are those comprising at least one function, such as: an alkoxysilane, silanol, a primary, secondary or tertiary amine which is cyclic or non-cyclic, a thiol or an epoxide.

“Isoprene elastomer” is understood to mean an isoprene homopolymer or copolymer, in other words a diene elastomer selected from the group consisting of natural rubber (NR), which may be plasticized or peptized, synthetic polyisoprenes (IRs), the various isoprene copolymers, in particular isoprene/styrene (SIRs), isoprene/butadiene (BIRs) or isoprene/butadiene/styrene (SBIRs) copolymers, and the mixtures of these elastomers.

The composition according to the invention is preferably based on at least one isoprene elastomer selected from the group consisting of natural rubber, synthetic polyisoprenes and their mixtures, advantageously from the group consisting of natural rubber, polyisoprenes comprising a content by weight of cis-1,4-bonds of at least 90%, more preferentially of at least 98%, with respect to the weight of isoprene elastomer, and their mixtures.

When it comprises a diene elastomer other than an isoprene elastomer, and although it can comprise any type of diene elastomer, the composition according to the invention will advantageously comprise an essentially unsaturated diene elastomer, in particular of the (a′) or (b′) type described above.

The diene elastomer other than an isoprene elastomer of the composition according to the invention can preferentially be chosen from the group of highly unsaturated diene elastomers consisting of polybutadienes (abbreviated to “BRs”), butadiene copolymers and the mixtures of these elastomers. Such copolymers are more preferentially selected from the group consisting of butadiene/styrene copolymers (SBRs), butadiene/acrylonitrile copolymers (NBRs), butadiene/styrene/acrylonitrile copolymers (NSBRs) or a mixture of two or more of these compounds.

Preferably, the rubber composition according to the invention is based on at least 100 phr of at least one isoprene elastomer.

Preferably, the composition according to the invention does not contain a thermoplastic elastomer or contains less than 10 phr, preferably less than 5 phr, thereof.

Preferably, the composition according to the invention does not comprise polybutadienes or comprises less than 2 phr, preferentially less than 1 phr, preferably less than 0.5 phr, thereof. This is because, beyond these contents, the presence of polybutadiene (abbreviated to “BR”) is liable to reduce the cohesive properties of the composition according to the invention.

Reinforcing Filler

The composition according to the invention comprises a reinforcing filler predominantly comprising at least one carbon black, known as “CB black” in the context of the present invention, the said CB black exhibiting a BET specific surface at most equal to 30 m²/g and an oil absorption number of compressed sample (COAN) at least equal to 60 ml/100 g.

The COAN, or absorption number of compressed sample (Compressed Oil Absorption Number) of the carbon blacks is measured according to Standard ASTM D3493-16.

The BET specific surface of carbon blacks is measured according to Standard D6556-10 (multipoint (a minimum of 5 points) method—gas: nitrogen—relative pressure p/p₀ range: 0.1 to 0.3).

Preferably, the said CB black exhibits a BET specific surface of less than or equal to 25 m²/g, preferably a BET specific surface within a range extending from 15 to 25 m²/g.

Preferably again, the said CB black exhibits a COAN oil absorption number at least equal to 65 ml/100 g, preferably at least equal to 70 ml/100 g. Advantageously, the said CB black exhibits a COAN at most equal to 90 ml/100 g and preferably within a value range extending from 70 ml/100 g to 80 ml/100 g.

An example of such a “CB black” carbon black is S204, sold by Orion Engineered Carbon.

These carbon blacks can be used in the isolated state, as available commercially, or in any other form, for example as support for some of the rubber additives used. These carbon blacks might, for example, be already incorporated in the isoprene elastomer in the form of a masterbatch, produced by the dry or liquid route (see, for example, Applications WO 97/36724 and WO 99/16600).

The reinforcing filler can also comprise any type of reinforcing filler known for its abilities to reinforce a rubber composition which can be used for the manufacture of tyres, for example an organic filler, such as carbon black other than a CB black, a reinforcing inorganic filler, such as silica, or also a blend of these two types of filler. All carbon blacks, in particular blacks of the HAF, ISAF or SAF type, conventionally used in tyres (“tyre-grade” blacks), are suitable as carbon blacks other than a CB black. Among the latter, mention will more particularly be made of the reinforcing carbon blacks of the 100, 200 and 300 series (ASTM grades), such as, for example, the N115, N134, N234, N326, N330, N339, N347 and N375 blacks, or else, depending on the applications targeted, the blacks of higher series (for example N660, N683 or N772). The carbon blacks might, for example, be already incorporated in an isoprene elastomer in the form of a masterbatch (see, for example, Applications WO 97/36724 and WO 99/16600).

Mention may be made, as examples of organic fillers other than carbon blacks, of functionalized polyvinyl organic fillers, such as described in Applications WO-A-2006/069792, WO-A-2006/069793, WO-A-2008/003434 and WO-A-2008/003435.

“Reinforcing inorganic filler” should be understood, in the present patent application, by definition, as meaning any inorganic or mineral filler (whatever its colour and its origin, natural or synthetic), also known as “white filler”, “clear filler” or indeed even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state in which the reinforcing inorganic filler is provided is not important, whether it is in the form of a powder, of microbeads, of granules, of beads or any other appropriate densified form. Of course, “reinforcing inorganic filler” is also understood to mean mixtures of different reinforcing inorganic fillers, in particular of highly dispersible siliceous and/or aluminous fillers such as described hereinafter.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface such as described in Application WO 03/16837.

The BET specific surface of the silica is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas: nitrogen—degassing: 1 hour at 160° C.—relative pressure p/p₀ range: 0.05 to 0.17).

The CTAB specific surface of the silica is determined according to French Standard NF T 45-007 of November 1987 (method B).

The reinforcing inorganic filler used, in particular if it is silica, preferably has a BET specific surface of between 45 and 400 m²/g, more preferentially of between 60 and 300 m²/g.

In order to couple the reinforcing inorganic filler to the elastomer, use may optionally be made, in a known way, of an at least bifunctional coupling agent (or bonding agent) intended to provide a satisfactory connection, of chemical and/or physical nature, between the inorganic filler (surface of its particles) and the elastomer, in particular organosilanes or polyorganosiloxanes which are bifunctional.

Use may in particular be made of silane polysulfides, referred to as “symmetrical” or “asymmetrical” depending on their specific structure, such as described, for example, in Applications WO 03/002648 (or US 2005/016651) and WO 03/002649 (or US 2005/016650).

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Use is made in particular, among these compounds, of bis(3-triethoxysilylpropyl) tetrasulfide, abbreviated to TESPT, of formula [(C₂H₅O)₃Si(CH₂)₃S₂]₂, or bis(3-triethoxysilylpropyl) disulfide, abbreviated to TESPD, of formula [(C₂H₅O)₃Si(CH₂)₃S]₂. Mention will also be made, as preferential examples, of bis(mono(C₁-C₄)alkoxyldi(C₁-C₄)alkylsilylpropyl) polysulfides (in particular disulfides, trisulfides or tetrasulfides), more particularly bis(monoethoxydimethylsilylpropyl) tetrasulfide, such as described in Patent Application US 2004/132880.

Mention will in particular be made, as coupling agent other than alkoxysilane polysulfide, of bifunctional POSs (polyorganosiloxanes) or else of hydroxysilane polysulfides, such as described in Patent Applications WO 02/30939 and WO 02/31041, or else of silanes or POSs bearing azodicarbonyl functional groups, such as described, for example, in Patent Applications WO 2006/125532, WO 2006/125533 and WO 2006/125534.

In the rubber compositions in accordance with the invention, the coupling agent is present at a content corresponding to a range extending from 5% to 15% by weight, with respect to the weight of silica. Preferably, the content of coupling agent is within a range extending from 5% to 11% by weight, with respect to the weight of silica.

A person skilled in the art will understand that use might be made, as filler equivalent to the reinforcing inorganic filler described in the present section, of a reinforcing filler of another nature, in particular organic in nature, provided that this reinforcing filler is covered with an inorganic layer, such as silica, or else comprises, at its surface, functional sites, in particular hydroxyl sites, making it possible to establish the bond between the filler and the elastomer in the presence or absence of a covering or coupling agent.

The content of CB black in the rubber composition is advantageously within a range of values extending from 20 to 80 phr, this range of values making it possible to obtain a tyre, the endurance and rolling resistance properties of which are improved. Preferably, the content of CB black is within a range extending from 35 to 70 phr, preferentially from 40 to 65 phr and preferably from 45 to 60 phr.

The reinforcing filler predominantly, that is to say at least 50% by weight, comprises CB black. Preferably, the reinforcing filler comprises 60%, 70%, 80%, 90% by weight of CB black. Very preferably, the reinforcing filler consists of CB black.

The composition according to the invention does not comprise silica, or comprises at most 10 phr, advantageously at most 5 phr, thereof.

The said composition does not comprise carbon black, the BET specific surface of which is greater than 30 m²/g and the COAN of which is greater than 40 ml/100 g, or comprises at most 10 phr, advantageously at most 5 phr, thereof.

Preferably, the composition according to the invention does not comprise carbon black, the BET specific surface of which is less than 15 m²/g, or comprises at most 10 phr, advantageously at most 5 phr, thereof.

Crosslinking System

The crosslinking system can be any type of system known to a person skilled in the art in the field of rubber compositions for tyres. It can in particular be based on sulfur, and/or on peroxide and/or on bismaleimides.

Preferentially, the crosslinking system is based on sulfur; it is then called a vulcanization system. The sulfur can be contributed in any form, in particular in the form of molecular sulfur, or of a sulfur-donating agent. At least one vulcanization accelerator is also preferentially present, and, optionally, also preferentially, use may be made of various known vulcanization activators, such as zinc oxide, stearic acid or equivalent compound, such as stearic acid salts, and salts of transition metals, guanidine derivatives (in particular diphenylguanidine), or also known vulcanization retarders.

The sulfur is used at a preferred content of between 2 and 6 phr, in particular between 3 and 5 phr. The vulcanization accelerator is used at a preferential content within a range extending from 0.3 to 1.2 phr, preferably extending from 0.5 to 1 phr.

Use may be made, as accelerator, of any compound capable of acting as accelerator of the vulcanization of diene elastomers in the presence of sulfur, in particular accelerators of the thiazole type, and also their derivatives, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and the mixtures of these compounds.

Various Additives

The rubber composition in accordance with the invention can also comprise all or a portion of the usual additives customarily used in elastomer compositions, such as, for example, pigments, protective agents, such as antiozone waxes, chemical antiozonants or antioxidants, plasticizing agents, anti-fatigue agents, reinforcing resins, secondary vulcanization accelerators, vulcanization activators, and the like.

The composition according to the invention can in particular comprise an alkaline earth, alkali or lanthanide metal salt.

The salt of an alkaline earth, alkali or lanthanide metal can advantageously be an acetylacetonate of an alkaline earth, alkali or lanthanide metal.

Preferably, the alkaline earth, alkali or lanthanide metal of the salt is selected from the group consisting of lithium, sodium, potassium, calcium, magnesium, lanthanum, cerium, praseodymium, neodymium, samarium, erbium and their mixtures. Preferably again, the salt of an alkaline earth, alkali or lanthanide metal is a magnesium or neodymium salt. In other words, the salt of an alkaline earth, alkali or lanthanide metal is advantageously a magnesium or neodymium acetylacetonate, preferably a magnesium acetylacetonate.

The content of the alkaline earth, alkali or lanthanide metal salt can, for example, be within a range extending from 0.1 to 5 phr, preferably from 0.5 to 4 phr and more preferentially from 0.5 to 2 phr.

The composition according to the invention can additionally comprise a cobalt salt. For example, the cobalt salt can be selected from the group consisting of abietates, acetylacetonates, tallates, naphthenates, resinates and their mixtures. The content of cobalt salt can advantageously be within a range extending from 0.5 to 3 phr, preferentially from 0.5 to 2 phr, preferably from 0.5 to 1.2 phr.

The composition according to the invention can additionally comprise an antioxidant selected from the group consisting of substituted p-phenylenediamines, substituted diphenylamines, substituted triphenylamines, quinoline derivatives and their mixtures. Preferably, the antioxidant is selected from the group consisting of substituted p-phenylenediamines and their mixtures. The content of antioxidant can advantageously be within a range extending from 1 to 5 phr, preferably from 1 to 3 phr.

Moreover, the composition can comprise a vulcanization retarder or be free thereof. For example, the composition according to the invention can contain less than 1 phr, preferably less than 0.6 phr, preferably less than 0.3 phr, of vulcanization retarder. Mention may be made, as example of vulcanization retarder, of N-cyclohexylthiophthalimide (CTP), for example sold under the name Vulkalent G by Lanxess.

Advantageously, the composition according to the invention does not comprise resorcinol and/or resorcinol derivative and/or hexamethylenetriamine and/or melamine derivative, or comprises less than 0.5 phr, preferably less than 0.4 phr, thereof. Preferably again, the composition according to the invention does not comprise reinforcing resin or comprises less than 0.5 phr, preferably less than 0.4 phr, thereof.

Finished or Semi-Finished Rubber Articles

Another subject-matter of the present invention is a finished or semi-finished rubber article, and also a tyre, comprising a composition according to the invention. Articles and tyres are concerned both in the raw state (that is to say, before curing) and in the cured state (that is to say, after crosslinking or vulcanization).

It is possible to define, within the tyre, three types of regions:
The radially exterior region in contact with the ambient air, this region being essentially composed of the tread and of the external sidewall of the tyre. An external sidewall is an elastomeric layer positioned outside the carcass reinforcement with respect to the internal cavity of the tyre, between the crown and the bead, so as to completely or partially cover the region of the carcass reinforcement extending from the crown to the bead.
The radially interior region in contact with the inflation gas, this region generally being composed of the layer airtight to the inflation gases, sometimes known as interior airtight layer or inner liner.
The internal region of the tyre, that is to say that between the exterior and interior regions. This region includes layers or plies which are referred to here as internal layers of the tyre. These are, for example, carcass plies, tread underlayers, tyre belt plies or any other layer which is not in contact with the ambient air or the inflation gas of the tyre.

The composition defined in the present description is particularly well suited to the internal layers of the tyres.

The finished or semi-finished rubber article according to the invention or the internal layer of the tyre according to the invention can comprise at least one textile or metal reinforcing element. Any textile or metal reinforcer known to a person skilled in the art may be concerned.

Reinforcing element, or metal or textile reinforcing element is understood to mean that the said reinforcing element can be wholly or partially made of metal or textile. In particular, the said reinforcing element can be of textile nature, that is to say made of an organic material, in particular a polymeric material, or an inorganic material, such as, for example, glass, quartz, basalt or carbon. The polymeric materials can be of the thermoplastic type, such as, for example, aliphatic polyamides, in particular polyamides 6,6, and polyesters, in particular polyethylene terephthalate. The polymeric materials can be of the non-thermoplastic type, such as, for example, aromatic polyamides, in particular aramid, and cellulose, either natural or artificial, in particular rayon.

The said reinforcing element can be of metallic nature, that is to say comprise a metal selected from the group consisting of iron, copper, zinc, tin, aluminium, cobalt, nickel and the alloys comprising at least one of these metals. The alloys can, for example, be binary or ternary alloys, such as steel, bronze and brass.

In a specific arrangement, the said reinforcing element comprises a metal surface.

The metal surface of the reinforcing element constitutes at least a part and advantageously the whole of the surface of the said reinforcing element and is intended to come into contact with the composition according to the invention.

The composition according to the invention coats at least a part of the reinforcing element, advantageously the whole of the said reinforcing element.

The reinforcing element is advantageously partly or completely made of metal, the metal part comprising at least the metal surface. Preferably, the whole of the reinforcing element is made of metal.

According to a first alternative form of the invention, the metal surface of the reinforcing element is made of a different material from the remainder of the reinforcing element. In other words, the reinforcing element is made of a material which is at least partly, advantageously completely, covered with a metal layer which constitutes the metal surface.

The material at least partly, advantageously completely, covered with the metal surface is metallic or non-metallic, preferably metallic, in nature.

According to a second alternative form of the invention, the reinforcing element is made of one and the same material, in which case the reinforcing element is made of a metal which is identical to the metal of the metal surface.

According to one embodiment of the invention, the metal surface comprises a metal selected from the group consisting of iron, copper, zinc, tin, aluminium, cobalt, nickel and the alloys comprising at least one of these metals. The alloys can, for example, be binary or ternary alloys, such as steel, bronze and brass. Preferably, the metal of the metal surface is iron, copper, tin, zinc or an alloy comprising at least one of these metals. More preferentially, the metal of the metal surface is steel, brass (Cu—Zn alloy), zinc or bronze (Cu—Sn alloy), more preferably still brass or zinc and very preferably brass.

In the present patent application, the expression “the metal of the metal surface is the metal denoted hereinafter” amounts to saying that the metal surface is made of metal denoted hereinafter. For example, the expression “the metal of the metal surface is brass” written above means that the metal surface is made of brass. As certain metals are subject to oxidation on contact with ambient air, the metal may be partly oxidized, with the exception of stainless steel.

When the metal surface is made of steel, the steel is preferentially a carbon steel or a stainless steel. When the steel is a carbon steel, its carbon content is preferably between 0.01% and 1.2% or between 0.05% and 1.2%, or else between 0.2% and 1.2%, in particular between 0.4% and 1.1%. When the steel is stainless, it preferably comprises at least 11% of chromium and at least 50% of iron.

The reinforcing element can be in any form. Preferably, the reinforcing element is provided in the form of a thread or of a cord.

Tyre

The invention also relates to a tyre comprising a rubber composition according to the invention. The present invention relates in particular to tyres intended to equip motor vehicles of passenger vehicle type, SUVs (“Sport Utility Vehicles”), or two-wheel vehicles (in particular motorcycles), or aircraft, or also industrial vehicles chosen from vans, heavy-duty vehicles—that is to say, underground trains, buses, heavy road transport vehicles (lorries, tractors, trailers) or off-road vehicles, such as heavy agricultural vehicles or earthmoving equipment—, and others, and preferably to tyres intended to equip vehicles of heavy-duty type.

The tyre having a radial carcass reinforcement according to the invention mainly comprises, as well known to a person skilled in the art, a tread, two beads each reinforced with a bead wire, two sidewalls connecting the beads to the tread, a carcass reinforcement extending from one bead to the other wound around the two bead wires in each bead and comprising a turn-up positioned, for example, towards the outside of the tyre, and an airtight layer (inner liner) extending between the two beads and located axially inside the carcass reinforcement. A stiff crown reinforcement is positioned circumferentially between the carcass reinforcement and the tread. The tyre advantageously comprises a “internal reinforcer” layer located between the airtight layer and the carcass reinforcement and extending from one bead to the other.

Preferably, the invention relates to a tyre in which the rubber composition according to the invention is present in at least one internal layer of the said tyre.

Advantageously, the said internal layer of the said tyre is selected from the group consisting of carcass plies, crown plies, bead-wire fillings, crown feet, decoupling layers, edge rubbers, padding rubbers, the tread underlayer, the internal reinforcing layer and the combinations of these internal layers and preferably selected from the group consisting of carcass plies, crown plies, crown feet, decoupling layers, edge rubbers, the internal reinforcing layer and the combinations of these internal layers. In the present text, the term “edge rubber” is understood to mean a layer positioned in the tyre directly in contact with the end of a reinforcing ply, with the end of a reinforcing element or with another edge rubber.

The composition according to the invention is particularly well suited for the rubber layers C described in Applications FR 2 981 297 and FR 2 981 298, or the working crown layer calendering layers described in Application FR 2 981 299.

The tyre according to the invention can, for example, be a tyre as defined in Application FR 2 981 297 or FR 2 981 298, in which the composition C comprises or consists of a composition according to the present invention. The tyre according to the invention can also be a tyre as defined in Application FR 2 981 299 in which the calendering layer of at least one working crown layer comprises or consists of a composition according to the present invention.

This is because there exist stresses at the crown reinforcement, and more particularly shear stresses between the crown layers, combined with a not insignificant rise in the operating temperature at the ends of these layers which can limit the endurance of the crown reinforcement. The use of the composition according to the invention, which makes it possible to improve the rolling resistance and the endurance, in particular with regard to thermal ageing, is thus particularly advantageous.

Thus, in a preferred arrangement, the invention relates to a tyre having a radial carcass reinforcement comprising a crown reinforcement formed of at least two superimposed working plies which are formed of parallel reinforcing elements within each ply which intersect from one ply to the following, forming angles with the circumferential direction of between 10° and 45°, a rubbery mixture layer C being positioned between at least the ends of the said at least two working plies, characterized in that the rubbery mixture layer C is a rubber composition according to the invention.

In another preferred arrangement, the invention relates to a tyre having a radial carcass reinforcement comprising a crown reinforcement formed of at least two superimposed working plies, each formed of parallel reinforcing elements inserted between two rubbery mixture calendering layers, which elements intersect from one ply to the other, forming angles with the circumferential direction of between 10° and 45°, characterized in that at least one calendering layer of at least one working ply is a composition according to the invention.

In either of these preferred arrangements, the said crown reinforcement advantageously also comprises at least one layer of circumferential metal reinforcing elements.

The at least one layer of circumferential metal reinforcing elements is a layer comprising metal reinforcing elements which are parallel to one another and which form angles with the circumferential direction within the range +2.5° to −2.5°, i.e. substantially around 0°.

In either of these preferred arrangements, the at least one layer of circumferential metal reinforcing elements is advantageously positioned radially between two working plies.

The presence of the at least one layer of circumferential metal reinforcing elements advantageously makes it possible to use, in the rubber composition according to the invention, a content of CB black within the range of values extending from 45 to 60 phr, the reinforcing filler preferentially consisting of the said CB black.

Preparation of the Rubber Compositions

The rubber composition in accordance with the invention is manufactured in appropriate mixers using two successive preparation phases well known to a person skilled in the art:
a first phase of thermomechanical working or kneading (“non-productive” phase), which can be carried out in a single thermomechanical stage during which all the necessary constituents, in particular the elastomeric matrix, the fillers and the optional other various additives, with the exception of the crosslinking system, are introduced into an appropriate mixer, such as a standard internal mixer (for example of ‘Banbury’ type). The incorporation of the filler in the elastomer can be carried out in one or more goes by thermomechanically kneading. In the case where the filler is already incorporated, in all or in part, in the elastomer in the form of a masterbatch, as is described, for example, in Applications WO 97/36724 and WO 99/16600, it is the masterbatch which is directly kneaded and, if appropriate, the other elastomers or fillers present in the composition which are not in the masterbatch form, and also the optional other various additives other than the crosslinking system, are incorporated.

The non-productive phase is carried out at high temperature, up to a maximum temperature of between 110° C. and 190° C., preferably between 130° C. and 180° C., for a period of time generally of between 1 and 15 minutes.
a second phase of mechanical working (“productive” phase), which is carried out in an external mixer, such as an open mill, after cooling the mixture obtained during the first non-productive phase down to a lower temperature, typically of less than 110° C., for example between 40° C. and 100° C. The crosslinking system is then incorporated and the combined mixture is then mixed for a few minutes, for example between 2 and 15 min.

The final composition thus obtained is subsequently calendered, for example in the form of a sheet or of a plaque, in particular for a laboratory characterization, or also extruded in the form of a rubber semi-finished (or profiled) element which can be used, for example, as an internal layer in a tyre.

The composition can be either in the raw state (before crosslinking or vulcanization) or in the cured state (after crosslinking or vulcanization), or can be a semi-finished product which can be used in a tyre.

The crosslinking of the composition can be carried out in a way known to a person skilled in the art, for example at a temperature of between 130° C. and 200° C., under pressure.

### EXAMPLES

Measurements and Tests Used

Dynamic Properties

The dynamic property tan(δ)ₘₐₓ was measured on a viscosity analyser (Metravib VA4000) according to Standard ASTM D 5992-96. The response of a sample of vulcanized composition (cylindrical test specimen with a thickness of 4 mm and with a cross section of 400 mm²), subjected to a simple alternating sinusoidal shear stress, at the frequency of 10 Hz and at the temperature of 100° C., is recorded. A strain amplitude sweep was carried out from 0.1% to 100% (outward cycle) and then from 100% to 0.1% (return cycle). The result made use of is the loss factor (tan(δ)). The maximum value of tan(δ) observed (tan(δ)ₘₐₓ), between the values at 0.1% and at 100% strain (Payne effect), has been shown for the return cycle.

The rolling resistance is the resistance which appears when the tyre rolls. It is represented by the hysteresis losses related to the deformation of the tyre during a revolution. The frequency values related to the revolution of the tyre correspond to tan(δ) values measured between 30 and 100° C. The tan(δ) value at 100° C. thus corresponds to an indicator of the rolling resistance of a heavy-duty tyre when rolling.

Tensile Tests

The tests were carried out in accordance with French Standard NF T 46-002 of September 1988. All the tensile measurements were carried out under the standard conditions of temperature (23±2° C.) and hygrometry (50%±5% relative humidity), according to French Standard NF T 40-101 (December 1979).

At second elongation (that is to say, after accommodation), the nominal secant modulus, calculated by reducing to the initial cross section of the test specimen, (or apparent stress, in MPa) was measured at 10% elongation, denoted MA₁₀, on samples cured at 140° C. for 50 minutes.

The elongations at break (EB in %), at 23° C.±2° C., were also measured according to Standard NF T 46-002 on samples cured at 140° C. for 50 minutes.

Preparation of the Compositions

The tests which follow are carried out in the following way: the diene elastomer, the reinforcing filler and also the various other ingredients, with the exception of the vulcanization system, are successively introduced into an internal mixer (final degree of filling: approximately 70% by volume), the initial vessel temperature of which is approximately 60° C. Thermomechanical working (non-productive phase) is then carried out in one stage, which lasts in total approximately from 3 to 4 min, until a maximum “dropping” temperature of 165° C. is reached.

The mixture thus obtained is recovered and cooled and then the vulcanization system is incorporated on a mixer (homofinisher) at 30° C., everything being mixed (productive phase) for an appropriate time (for example between 5 and 12 min).

The compositions thus obtained are subsequently calendered, in the form of plaques (thickness of 2 to 3 mm) or of thin sheets of rubber, and are then subjected to a curing stage at 140° C. for 50 min, before the measurement of their physical or mechanical properties.

### Example 1

Tests were carried out with different compositions produced according to the invention and according to the prior art. The mixtures C1 and C2 correspond respectively to the mixtures having a low hysteresis loss 1 and 3 of the document FR 2 981 298, C1 comprising a carbon black reinforcing filler and C2 a silica reinforcing filler.

The mixtures, the compositions of which are shown hereinafter, are prepared. The modulus of elasticity under tension at 10% elongation (MA₁₀) and the tan(δ)ₘₐₓ values for each are measured, these values being expressed in base 100 taking the mixture C1 for reference. The carbon black content of the mixture I1 is adjusted in order to obtain the same modulus MA₁₀ as the mixture C1.

| | C1 | C2 | I1 |
|---|---|---|---|
| NR (1) | 100 | 100 | 100 |
| Black N326 (2) | 47 | | |
| Silica 165G (3) | | 46 | |
| Silane-on-black | | 8.3 | |
| Black S204 (4) | | | 53 |
| Antioxidant (6PPD) (5) | 1.5 | 2 | 1.5 |
| Stearic acid (6) | 0.9 | 1 | 0.9 |
| Zinc oxide (7) | 7.5 | 8 | 7.5 |
| Cobalt salt (8) | 1.1 | 1.1 | 1.1 |
| Sulfur | 4.5 | 4.8 | 4.5 |
| DCBS accelerator (9) | 0.8 | | 0.8 |
| TBBS accelerator (10) | | 1.01 | |
| DPG co-accelerator (11) | | 1.1 | |
| Retarder (12) | 0.15 | 0.2 | 0.15 |
| MA₁₀ (MPa) | 100 | 121 | 100 |
| Tan(δ)ₘₐₓ | 100 | 64 | 51 |

(1) Natural rubber
(2) Carbon black N326 (according to Standard ASTM D-1765)
(3) Silica “165G” sold by Solvay
(4) Carbon black “S204” from Orion Engineered Carbon
(5) N-(1,3-Dimethylbutyl)-N-phenyl-para-phenylenediamine “Santoflex 6-PPD” from Flexsys
(6) Stearin (Pristerene 4931 from Uniqema)
(7) Zinc oxide, industrial grade, Umicore
(8) Cobalt naphthenate - No. of product 60830 from Fluka
(9) N,N-Dicyclohexylbenzothiazole-2-sulfenamide from Flexsys
(10) N-(tert-Butyl)-2-benzothiazolesulfenamide “Santocure TBBS” from Flexsys
(11) Diphenylguanidine (Perkacit DPG from Flexsys)
(12) N-Cyclohexylthiophthalimide, sold under the name “Vulkalent G” by Lanxess

The amounts of the constituents are expressed in phr (parts by weight per hundred parts of elastomers).

It is observed that, at similar stiffness, the composition according to the invention exhibits lower tan(δ)ₘₐₓ hysteresis losses than the control mixture C1. The composition according to the invention also exhibits lower hysteresis losses than the low-loss silica-based mixture C2 and will make it possible to obtain a tyre exhibiting a lower rolling resistance.

### Example 2

In this example, the composition in accordance I1 is compared with a mixture C3 of the prior art exhibiting a similar stiffness and a low hysteresis loss. The mixture C3 corresponds to the mixture 4 of the document FR 2 981 298.

The mixtures, the compositions of which are shown hereinafter, are prepared. The modulus of elasticity under tension at 10% elongation (MA₁₀) and the tan(δ)ₘₐₓ values for each are measured, these values being expressed in base 100 taking the mixture C3 for reference.

The percentages of elongation at break are determined after preparation of the test specimens and after the test specimens have been subjected to a heat treatment at 110° C. under nitrogen for 10 days. The change in the percentage of elongation at break makes it possible to estimate the resistance of the composition to thermal ageing. The results are expressed on a base 100 for each test specimen, the value of 100 corresponding to the elongation at break of the test specimen prior to the heat treatment.

| | C3 | I2 |
|---|---|---|
| NR | 100 | 100 |
| Black N683 | 44 | |
| Black S204 | | 53 |
| Antioxidant (6PPD) | 1 | 1.5 |
| Stearic acid | 0.65 | 0.9 |
| Zinc oxide | 9.3 | 7 |
| Cobalt salt | 1.1 | 1.1 |
| Sulfur | 6.1 | 4.5 |
| DCBS accelerator | 0.9 | 0.8 |
| CTP retarder (PVI) | 0.25 | 0.15 |
| MA₁₀ (MPa) | 100 | 98 |
| Tan(δ)ₘₐₓ | 100 | 89 |
| % EB (base 100) | 100 | 100 |
| % EB (base 100) | 66.7 | 85.3 |
| After ageing at 110° C. under nitrogen | | |
| for 10 d | | |

It is observed that the mixture in accordance with the invention exhibits a reduced hysteresis for a similar stiffness to the composition C3, and exhibits a better resistance to thermal ageing with an elongation at break which is less reduced after ageing.

1.-23. (canceled)

24. A rubber composition based on:
an elastomeric matrix comprising at least 90 phr of at least one isoprene elastomer;
a reinforcing filler predominantly comprising at least one carbon black CB exhibiting a BET specific surface at most equal to 30 m²/g and an oil absorption number of compressed sample COAN at least equal to 60 ml/100 g; and
on a crosslinking system,
wherein the rubber composition does not comprise, or comprises at most 10 phr of, a carbon black, a BET specific surface of which is greater than 30 m²/g and an oil absorption number of compressed sample COAN of which is greater than 40 ml/100 g, and
wherein the rubber composition does not comprise, or comprises at most 10 phr of, silica.

25. The rubber composition according to claim 24, wherein the at least one isoprene elastomer is selected from the group consisting of natural rubber, synthetic polyisoprenes, isoprene copolymers and mixtures thereof.

26. The rubber composition according to claim 24, wherein the at least one carbon black CB exhibits a COAN number at least equal to 65 ml/100 g.

27. The rubber composition according to claim 24, wherein the BET specific surface of the at least one carbon black CB is at most equal to 25 m²/g.

28. The rubber composition according to claim 24, wherein the reinforcing filler comprises at least 60% by weight of the at least one carbon black CB.

29. The rubber composition according to claim 24, wherein the rubber composition does not comprise, or comprises less than 2 phr of, polybutadienes.

30. The rubber composition according to claim 24, wherein the crosslinking system is a vulcanization system based on molecular sulfur, on a sulfur-donating agent, or on both molecular sulfur and a sulfur-donating agent.

31. The rubber composition according to claim 30, wherein the vulcanization system comprises between 2 and 6 phr of sulfur.

32. A finished or semi-finished rubber article comprising a rubber composition according to claim 24.

33. A tire comprising a rubber composition according to claim 24.

34. The tire according to claim 33, wherein the rubber composition is present in at least one internal layer of the tire.

35. The tire according to claim 34, wherein the at least one internal layer is selected from the group consisting of carcass plies, crown plies, bead-wire fillings, crown feet, decoupling layers, edge rubbers, padding rubbers, a tread underlayer, an internal reinforcing layer and combinations thereof.

36. The tire according to claim 35, wherein the at least one internal layer is selected from the group consisting of carcass plies, crown plies, crown feet, decoupling layers, edge rubbers, the internal reinforcing layer and combinations thereof.

37. A tire having a radial carcass reinforcement comprising a crown reinforcement formed of at least two superimposed working plies which are formed of parallel reinforcing elements within each ply which intersect, forming angles with the circumferential direction of between 10° and 45°, from one ply to a rubbery mixture layer being positioned between at least the ends of the at least two working plies, wherein the rubbery mixture layer is a rubber composition according to claim 24.

38. A tire having a radial carcass reinforcement comprising a crown reinforcement formed of at least two superimposed working plies, each formed of parallel reinforcing elements inserted between two rubbery mixture calendering layers, which elements intersect from one ply to the other, forming angles with the circumferential direction of between 10° and 45°, wherein, in at least one calendering layer of at least one working ply, is a rubber composition according to claim 24.
